(19) United States
(12) Patent Application Publication
(10) Pub. No.: US 2026/0091821 A1
(43) Pub. Date: Apr. 2, 2026

(54) STEERING CONTROL SYSTEMS AND METHODS

(71) Applicant: GM GLOBAL TECHNOLOGY OPERATIONS LLC, Detroit, MI (US)

(72) Inventors: Yubiao ZHANG, Troy, MI (US); Bo YU, Novi, MI (US); Jacob Alan BOND, Rochester Hills, MI (US)

(21) Appl. No.: 18/901,310

(22) Filed: Sep. 30, 2024

(51) Int. Cl. B62D 5/04; B62D 5/00; B62D 6/00

(52) U.S. Cl. CPC B62D 5/0463; B62D 5/006; B62D 6/008

(57) ABSTRACT

A steer by wire (SBW) steering system of a vehicle includes: a steering feel motor configured to apply torque to a steering column and a steering wheel; a steering actuator motor configured to turn wheels of the vehicle; a steering assessment module configured to output instructions for a strength assessment of a driver; an infotainment module configured to, based on the instructions, output an instruction to the driver to hold the steering wheel at a first predetermined angle that is one of counterclockwise and counterclockwise relative to a second predetermined angle; and a steering actuator module configured to, based on the instructions, control the steering feel motor and output a predetermined torque to the steering column and the steering wheel in the other one of counterclockwise and counterclockwise direction for a predetermined period overlapping the instruction to the driver to hold the steering wheel at the first predetermined angle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle control systems and more particularly to systems and methods for steering systems of vehicles.

Vehicles include one or more torque producing devices, such as an internal combustion engine and/or an electric motor. A passenger of a vehicle rides within a passenger cabin (or passenger compartment) of the vehicle.

Vehicles may include one or more different types of sensors that sense vehicle surroundings. One example of a sensor that senses vehicle surroundings is a camera configured to capture images of the vehicle surroundings. Examples of such cameras include forward-facing cameras, rear-facing cameras, and side facing cameras. Another example of a sensor that senses vehicle surroundings includes a radar sensor configured to capture information regarding vehicle surroundings. Other examples of sensors that sense vehicle surroundings include sonar sensors and light detection and ranging (LIDAR) sensors configured to capture information regarding vehicle surroundings.

### SUMMARY

In a feature, a steer by wire (SBW) steering system of a vehicle includes: a steering feel motor configured to apply torque to a steering column and a steering wheel; a steering actuator motor configured to actuate one or more steering components and turn wheels of the vehicle; a steering assessment module configured to output instructions for a strength assessment of a driver of the vehicle; an infotainment module configured to, based on the instructions for the strength assessment, output an instruction to the driver to hold the steering wheel at a first predetermined angle that is one of counterclockwise and counterclockwise relative to a second predetermined angle; and a steering actuator module configured to, based on the instructions for the strength assessment, control the steering feel motor and output a predetermined torque to the steering column and the steering wheel in the other one of counterclockwise and counterclockwise direction for a predetermined period overlapping the instruction to the driver to hold the steering wheel at the first predetermined angle, where the steering assessment module is configured to determine muscle parameters of the driver based on steering wheel angle measurements taken during the predetermined period, and where the steering actuator module is configured to control torque output of the steering feel motor during driving of the vehicle based on the muscle parameters of the driver.

In further features, the muscle parameters include a muscle spring of the driver.

In further features, the muscle parameters include a damping coefficient of the driver.

In further features, the muscle parameters include a mass coefficient of the driver.

In further features, the strength assessment module is configured to determine the muscle parameters using one of an equation and a lookup table that relates steering wheel angles to muscle parameters.

In further features, the strength assessment module is configured to determine the muscle parameters using the equation

$$J \ddot{θ} = d \dot{θ} + k θ = τ ,$$

where J is a muscle spring value of the driver, \ddot{θ} is a second derivative of the steering wheel angle, d is a muscle damping value of the driver, \dot{θ} is a first derivative of the steering wheel angle, k is a muscle mass coefficient of the driver, θ is the SWA, and τ is the predetermined torque.

In further features, the strength assessment module is configured to determine the muscle parameters using Least Squares.

In further features: the steering assessment module is configured to determine a strength level of the driver based on the muscle parameters; and the steering actuator module is configured to: determine steering parameters based on the strength level; and control torque output of the steering feel motor during driving of the vehicle based on the steering parameters.

In further features, the steering parameters include a power assistance gain provided by the steering feel motor.

In further features, the steering parameters include a linearity boost provided by the steering feel motor.

In further features, the steering parameters include a steering stiffness provided by the steering feel motor.

In further features, the steering parameters include a steering wheel damping provided by the steering feel motor.

In further features, the steering parameters include a steering ratio provided by the steering feel motor.

In further features: the steering assessment module is configured to determine steering attributes based on the muscle parameters of the driver; and the infotainment module is configured to output a graphical illustration of the steering attributes.

In further features, the graphical illustration is a spider graph.

In further features, the steering attributes include a steering effort.

In further features, the steering attributes include a steering feedback.

In further features, the steering attributes include directness and sensitivity.

In further features, the steering attributes include returnability to center and a linearity.

In a feature, a steer by wire (SBW) steering method for a vehicle includes: by a steering feel motor, applying torque to a steering column and a steering wheel; actuating one or more steering components and turn wheels of the vehicle; outputting instructions for a strength assessment of a driver of the vehicle; based on the instructions for the strength assessment, outputting an instruction to the driver to hold the steering wheel at a first predetermined angle that is one of counterclockwise and counterclockwise relative to a second predetermined angle; based on the instructions for the strength assessment, controlling the steering feel motor and outputting a predetermined torque to the steering column and the steering wheel in the other one of counterclockwise and counterclockwise direction for a predetermined period overlapping the instruction to the driver to hold the steering wheel at the first predetermined angle; determining muscle parameters of the driver based on steering wheel angle measurements taken during the predetermined period; and controlling torque output of the steering feel motor during driving of the vehicle based on the muscle parameters of the driver.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a functional block diagram of an example implementation of a steer by wire steering system of the vehicle;

FIG. 3 is a functional block diagram of an example implementation of a steering control module;

FIG. 4 is a flowchart depicting an example method of performing a strength assessment of a driver;

FIG. 5 is an example graph of steering wheel angle, torque, and grip force versus time for a strength assessment;

FIG. 6 is a flowchart depicting an example method of controlling the steering feel motor based on the muscle parameters of the driver determined based on the strength assessment of the driver;

FIG. 7 includes an example table illustrating steering attributes and corresponding steering parameters; and

FIG. 8 includes an example graphical illustration of steering attributes for different drivers.

In the drawings, reference numbers may be reused to identify similar and/or identical elements.

### DETAILED DESCRIPTION

A vehicle includes a steering system, such as a steer by wire (SBW) steering system. In SBW systems, a steering column that is coupled to a steering wheel is not mechanically coupled to the components that turn wheels of the vehicle. Instead, a steering actuator motor actuates the components that turn the wheels of the vehicle based on an angle of rotation of the steering wheel/steering column or a steering rack position. A steering feel motor applies torque to the steering column in an effort to replicate what a driver would feel if the steering column was mechanically coupled to the components in a non-SBW steering system.

The present application involves performing a strength assessment of a driver of a vehicle including a SBW steering system. The strength assessment may include instructing the driver to hold the steering wheel at a predetermined position and applying negative torque to the steering wheel. A strength assessment module determines muscle parameters of the driver based on steering wheel measurements taken during the strength assessment. A steering control module controls the steering feel motor based on the muscle parameters of the driver to tailor what the driver feels via the steering wheel to the muscle parameters of the driver. This improves driver experience and improves customizability.

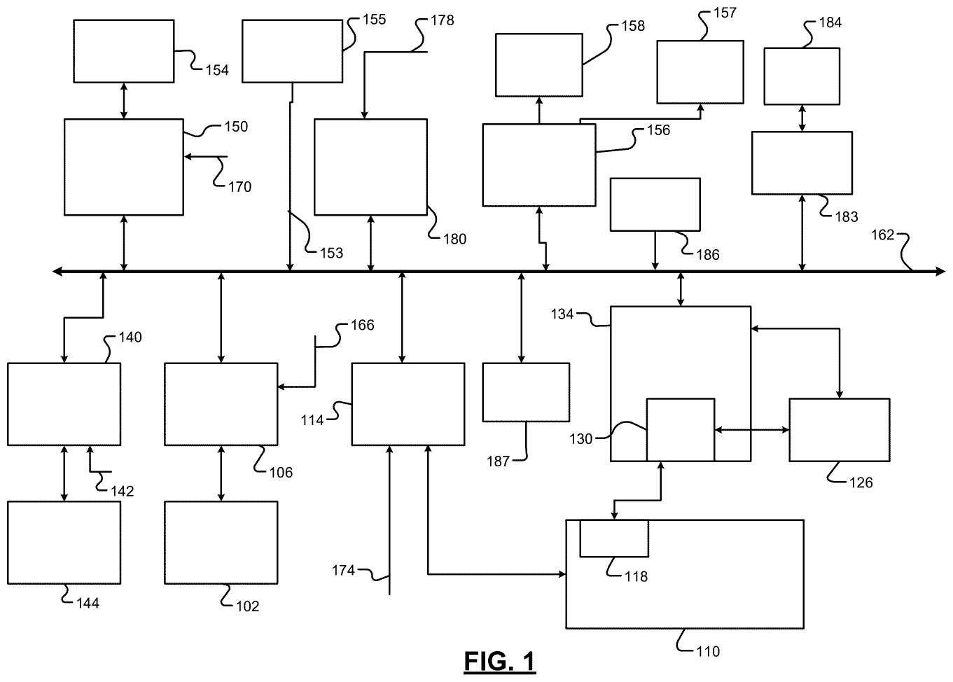

Referring now to FIG. 1, a functional block diagram of an example vehicle system is presented. While a vehicle system for a hybrid vehicle is shown and will be described, the present application is also applicable to non-hybrid vehicles, electric vehicles, fuel cell vehicles, and other types of vehicles. The present application is applicable to autonomous vehicles, semi-autonomous vehicles, non-autonomous vehicles, shared vehicles, non-shared vehicles, and other types of vehicles.

An engine 102 may combust an air/fuel mixture to generate drive torque. An engine control module (ECM) 106 controls the engine 102. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators. In some types of vehicles (e.g., electric vehicles), the engine 102 may be omitted.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system may include one or more electric motors. For example, an electric motor 118 may be implemented within the transmission 110 as shown in the example of FIG. 1. An electric motor can act as either a generator or as a motor at a given time. When acting as a generator, an electric motor converts mechanical energy into electrical energy. The electrical energy can be, for example, used to charge a battery 126 via a power control device (PCD) 130. When acting as a motor, an electric motor generates torque that may be used, for example, to supplement or replace torque output by the engine 102. While the example of one electric motor is provided, the vehicle may include zero or more than one electric motor.

A power inverter module (PIM) 134 may control the electric motor 118 and the PCD 130. The PCD 130 applies power from the battery 126 to the electric motor 118 based on signals from the PIM 134, and the PCD 130 provides power output by the electric motor 118, for example, to the battery 126. The PIM 134 may include, for example, an inverter.

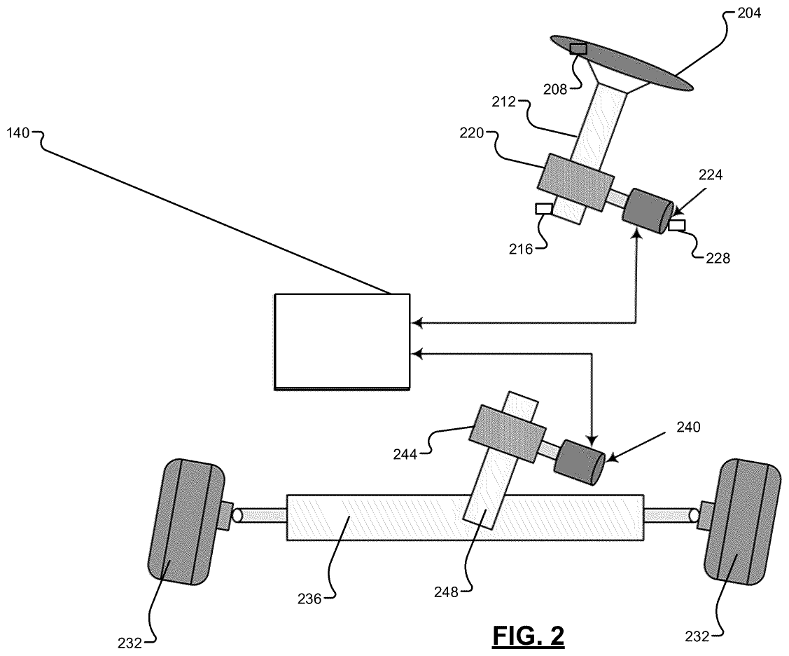

A steering control module 140 controls steering/turning of wheels of the vehicle, for example, based on driver turning of a steering wheel within the vehicle and/or steering commands from one or more vehicle control modules. A steering wheel angle (SWA) sensor (FIG. 2) may monitor rotational position of the steering wheel and generates a SWA 142 based on the position of the steering wheel. As an example, the steering control module 140 may control vehicle steering via an electronic power steering (EPS) motor 144 based on the SWA 142. However, the vehicle may include another type of steering system. The present application involves a steer by wire (SBW) steering system. A torque sensor (FIG. 2) may measure a torque of the driver applied to the steering wheel.

A brake control module 150 may selectively control (e.g., friction) brakes 154 of the vehicle based on one or more driver inputs, such as a brake pedal position (BPP) 170. Another driver input may be a cruise control input 153 from a cruise control module 155 when cruise control is enabled.

Modules of the vehicle may share parameters via a network 162, such as a controller area network (CAN). A CAN may also be referred to as a car area network. For example, the network 162 may include one or more data buses. Various parameters may be made available by a given module to other modules via the network 162.

The driver inputs may include, for example, an accelerator pedal position (APP) 166 which may be provided to the ECM 106. The BPP 170 may be provided to the brake control module 150. A position 174 of a park, reverse, neutral, drive lever (PRNDL) may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, or crank.

An infotainment module 183 may output various information via one or more output devices 184. The output devices 184 may include, for example, one or more displays (non-touch screen and/or touch screen), one or more other suitable types of video output devices, one or more speakers, one or more haptic devices, and/or one or more other suitable types of output devices.

The infotainment module 183 may output video via the one or more displays. The infotainment module 183 may output audio via the one or more speakers. The infotainment module 183 may output other feedback via one or more haptic devices. For example, haptic devices may be included with one or more seats, in one or more seat belts, in the steering wheel, etc. Examples of displays may include, for example, one or more displays (e.g., on a front console) of the vehicle, a head up display (HUD) that displays information via a substrate (e.g., windshield), one or more displays that drop downwardly or extend upwardly to form panoramic views, and/or one or more other suitable displays.

The vehicle may include a plurality of external sensors and cameras, generally illustrated in FIG. 1 by 186. One or more actions may be taken based on input from the external sensors and cameras 186. For example, the infotainment module 183 may display video, various views, and/or alerts on a display via input from the external sensors and cameras 186 during driving.

As another example, brake control module 150 and/or the steering control module 140 may apply the brakes 154 and/or steer the vehicle to prevent the vehicle colliding with an object around the vehicle.

The vehicle may include one or more additional control modules that are not shown, such as a chassis control module, a battery pack control module, etc. The vehicle may omit one or more of the control modules shown and discussed.

FIG. 2 is a functional block diagram of an example implementation of a steer by wire steering system of the vehicle. A driver rotates a steering wheel 204 to input requests to steer/turn the vehicle. For example, the driver may rotate the steering wheel 204 clockwise to input a request to turn the vehicle rightward. The driver may increasingly rotate the steering wheel 204 clockwise to input a request to turn the vehicle more sharply rightward. The driver may rotate the steering wheel 204 counterclockwise to input a request to turn the vehicle leftward. The driver may increasingly rotate the steering wheel 204 counterclockwise to input a request to turn the vehicle more sharply leftward. A grip strength sensor 208 may be included in the steering wheel 204 and measure a grip strength of a driver on the steering wheel 204.

The steering wheel 204 is coupled to a steering column 212. The steering column 212 rotates with the steering wheel 204. A SWA sensor 216 measures a rotational position/angle of the steering wheel 204, such as based on rotation of the steering column 212.

An actuator 220 surrounds the steering column 212. A steering feel motor 224 controls steering parameters felt by the driver via the steering wheel 204, such as by actuating the actuator 220. The steering feel motor 224 applies torque that can be felt by the driver via the steering wheel 204. A torque sensor 228 may measure a torque output of the steering feel motor 224. The steering control module 140 controls the steering feel motor 224, such as by controlling electrical power applied to the steering feel motor 224.

Wheels 232, such as front wheels of the vehicle, are coupled to one or more steering arms 236. Movement of the steering arm(s) 236 moves the wheels leftward and rightward to steer the vehicle leftward and rightward.

A steering actuator motor 240 controls movement of the steering arm(s) 236 via an actuator 244 and a second steering column 248. For example, the actuator 244 may surround the second steering column 248. The steering actuator motor 240 outputs torque to the second steering column 248 via the actuator 244, and the torque on the second steering column 248 moves the steering arm(s) 236. While the example of the second steering column 248 is provided, the present application is also applicable to other actuators, such as a belt or a ball screw drive.

The steering control module 140 controls the steering actuator motor 240, such as by controlling electrical power applied to the steering actuator motor 240. The steering control module 140 controls the steering actuator motor 240, such as based on the SWA 142 to steer the vehicle based on the SWA 142.

As illustrated in FIG. 2, the steering column 212 and the second steering column 248 are not physically connected and can rotate independently of each other.

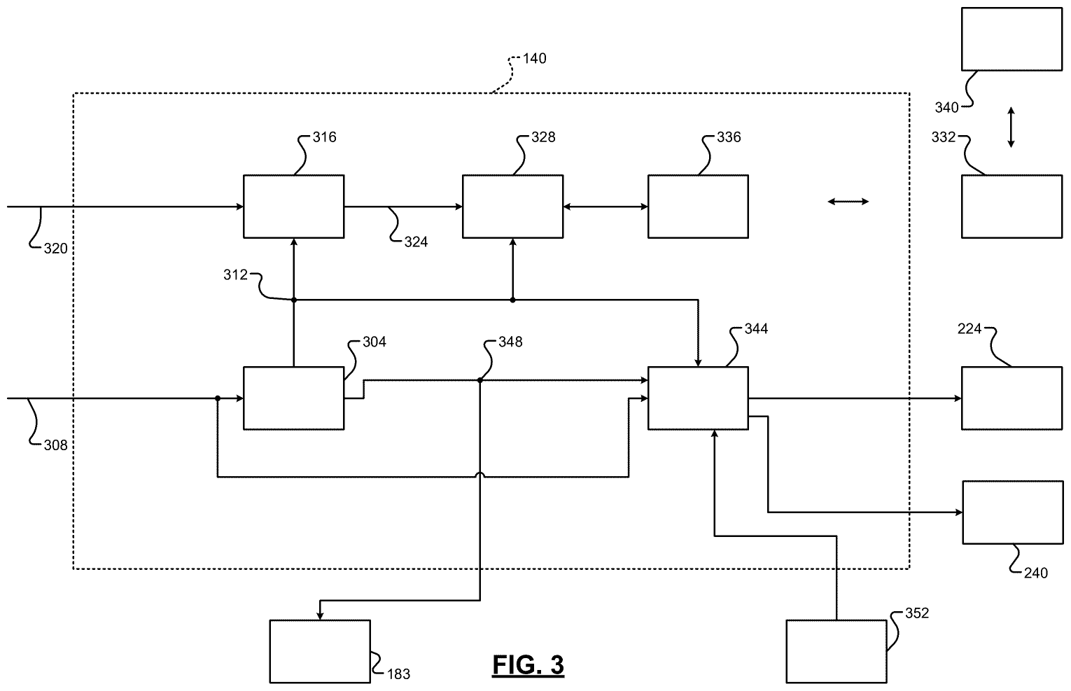

FIG. 3 is a functional block diagram of an example implementation of the steering control module 140. A strength assessment module 304 performs a strength assessment of the driver and determines muscle parameters (e.g., muscle spring, muscle damping, and muscle mass coefficient) based on steering wheel (SW) measurements 308 measured taken during the strength assessment. The SW measurements 308 may include, for example, the SWA 142, the torque measured by the sensor 228, and a grip strength measured by the grip strength sensor 208.

The strength assessment module 304 determines a strength level of the driver based on the muscle parameters, such as using a lookup table that relates muscle parameters to strength levels. The strength level and the muscle parameters are collectively illustrated by 312 (strength parameters).

A user identification module 316 identifies the driver using one or more driver biometric inputs 320. Examples of the driver biometric inputs 320 include one or more images including a face of the driver captured using a camera, a touch input (e.g., fingerprint) of the driver captured using a touch sensor, one or more voice/speech inputs of the driver captured via one or more microphones, and/or one or more inputs that can be used to identify the driver. The user identification module 316 may identify the driver by matching one or more of the driver biometric inputs 320 with one or more stored biometric parameters for different drivers (e.g., closest match). If no matching is made (e.g., confidence of matching<predetermined value), the user identification module 316 may create a new profile for a new driver and store the collected biometric parameters in association with the new driver. The user identification module 316 outputs an indicator 324 that indicates the driver identified.

A wireless transceiver module 328 wirelessly transmits and receives data from a remote server 332 via one or more antennas 336. For example, the wireless transceiver module 328 transmits the indicator 324 to the remote server 332 along with the strength parameters 312 of the driver. The remote server 332 stores the strength parameters 312 in association with the driver. The remote server 332 may notify the driver of one or more health conditions, for example, based on changes and/or trends in one or more of the strength parameters of the driver over time. The wireless transceiver module 328 may communicate with the remote server 332, for example, using a cellular network, a WiFi network, a satellite network, or another suitable type of wireless communication network.

In various implementations, one or more user computing devices 340 may communicate with the remote server 332, such as to view, update, input, and/or delete stored information associated with the profile of the driver. Examples of user computing devices include cell phones, tablet devices, computers, smart watches, and other types of devices.

A steering actuator module 344 controls (e.g., the torque output, such as magnitude and direction) the steering feel motor 224 and the steering actuator motor 240. The steering actuator module 344 may, for example, control power applied to the steering feel motor 224 and the steering actuator motor 240 from one or more batteries, such as battery 352. For example, during driving of the vehicle, the steering actuator module 344 controls the steering actuator motor 240 based on the SWA 142 to steer the vehicle according to rotation of the steering wheel 204 by the driver. During the driving, the steering actuator module 344 also controls the steering feel motor 224 based on one or more of the strength parameters (e.g., the strength level) to control what is felt by the driver via the steering wheel 204 during the driving.

The steering actuator module 344 also controls the steering feel motor 224 according to instructions 348 from the strength assessment module 304 for performance of the strength assessment. The infotainment module 183 also outputs information according to the instructions 348 via one or more of the output devices 184 (e.g., audibly via one or more speakers, visually via one or more displays) for the performance of the strength assessment. The strength assessment is discussed further below.

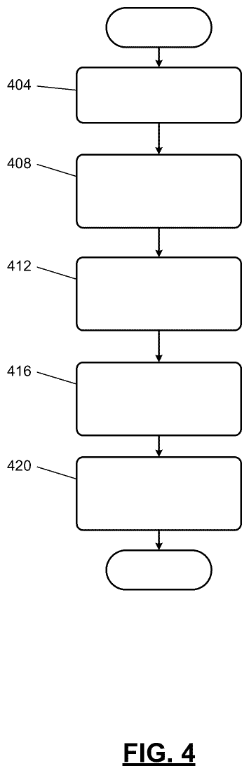

FIG. 4 is a flowchart depicting an example method of performing the strength assessment. At 404, the strength assessment module 304 generates the instructions 348 for the infotainment module 183 and the steering actuator module 344. Also at 404, pursuant to the instructions 348, the infotainment module 183 outputs one or more instructions within the passenger cabin (e.g., audibly via one or more speakers, visibly via one or more displays) for the driver to hold the steering wheel 204 at a predetermined non-zero steering wheel angle. As such, the driver should hold the steering wheel 204 at the predetermined steering wheel angle left or right of zero steering wheel angle. The vehicle travels forward in the direction of the longitudinal axis of the vehicle when at zero steering wheel angle. The predetermined steering wheel angle may be positive or negative and may be, for example, between 15 and 90 degrees or another suitable angle. Positive steering wheel angles may be clockwise relative to zero steering wheel angle and negative steering wheel angles may be counterclockwise relative to zero steering wheel angle or vice versa.

At 408, pursuant to the instructions 348, the steering actuator module 344 applies a predetermined negative torque to the steering wheel 204 for a predetermined period to counteract the torque applied by the driver to the steering wheel 204 to hold the steering wheel 204 at the predetermined steering wheel angle. Negative in this sense is expressed relative to the driver torque being positive. The predetermined torque may be, for example, 0.2-1.0 Newton meters (Nm) or another suitable magnitude. The predetermined period may be, for example, 0.1-1 second or another suitable predetermined period. For example, if the driver is to hold the steering wheel 204 in predetermined position that is clockwise relative to the zero steering wheel angle, the steering actuator module 344 applies torque in a counterclockwise direction. If the driver is to hold the steering wheel 204 in predetermined position that is counterclockwise relative to the zero steering wheel angle, the steering actuator module 344 applies torque in a clockwise direction.

At 412, the strength assessment module 304 records the SW measurements 308 during the application of the negative torque by the steering feel motor 224 and the torque (relative to the negative torque applied by the steering feel motor 224) by the driver. This includes, for example, the SWA 142 and may include the grip force.

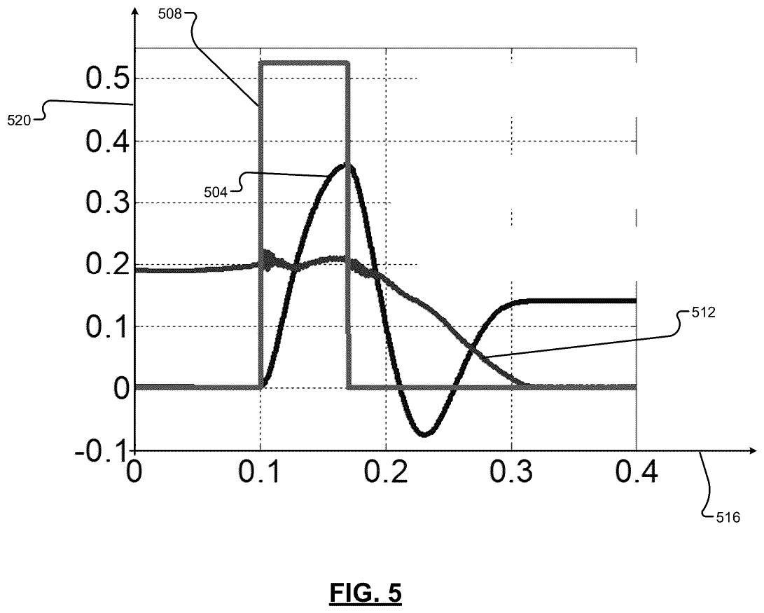

FIG. 5 includes an example graph of steering wheel angle 504, torque 508, and grip force 512 versus time 516. Torque axis 520 is also illustrated. As illustrated, a predetermined torque (in this example having a magnitude of approximately 0.5 Nm) is applied by the steering feel motor 224 for a predetermined period (in this example, approximately 0.08 seconds.

At 416, once the predetermined period has passed, the steering actuator module 344 stops the steering feel motor 224 from outputting the predetermined torque, such as by disconnecting the steering feel motor 224 from power. At 420, the strength assessment module 304 determines the muscle parameters of the driver.

The strength assessment module 304 determines the muscle parameters based on the steering wheel angle measured during a predetermined period including the predetermined period during which the steering feel motor 224 outputs the predetermined torque for the strength assessment. This predetermined period may start at or before the predetermined period during which the steering feel motor 224 outputs the predetermined torque for the strength assessment. This predetermined period may end at or after the end of the predetermined period during which the steering feel motor 224 outputs the predetermined torque for the strength assessment. The strength assessment module 304 may determine the muscle parameters of the driver using one of an equation and a lookup table that related measured steering wheel angles during the predetermined period to muscle parameters. In the example of a lookup table, the lookup table may be calibrated based on the predetermined torque τ. For example, the strength assessment module 304 may determine the muscle parameters using the equation:

$$J \ddot{θ} = d \dot{θ} + k θ = τ ,$$

where J is a muscle spring value of the driver, \ddot{θ} is the second derivative of the SWA, d is a muscle damping value of the driver, \dot{θ} is the first derivative of the SWA, k is a muscle mass coefficient of the driver, θ is the SWA, and τ is the predetermined torque applied by the steering feel motor 224. The muscle parameters of the driver in this example include J, d, and k. The strength assessment module 304 may determine the muscle parameters, for example, using Least Squares or in another suitable manner. In various implementations, the strength assessment module 304 may determine the muscle parameters using a neural network (NN), such as an artificial neural network (ANN). The strength assessment module 304 may determine the muscle parameters further based on the grip force in various implementations.

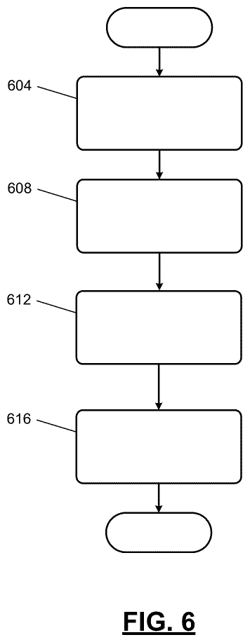

FIG. 6 is a flowchart depicting an example method of controlling the steering feel motor 224 based on the muscle parameters of the driver determined based on the strength assessment of the driver. Control begins at 604 where the strength assessment module 304 determines the muscle parameters of the driver as discussed above.

At 608, the strength assessment module 304 may determine the strength level of the driver based on the muscle parameters of the driver. The strength assessment module 304 may set the strength level to one of a discrete number of strength levels based on the muscle parameters being within predetermined criteria for that specific strength level. For example, the strength assessment module 304 may set the strength level to a first strength level when the muscle parameters satisfy a first predetermined set of criteria. The strength assessment module 304 may set the strength level to a second strength level when the muscle parameters satisfy a second predetermined set of criteria. The strength assessment module 304 may set the strength level to a third strength level when the muscle parameters satisfy a third predetermined set of criteria. The strength assessment module 304 may set the strength level to a fourth strength level when the muscle parameters satisfy a fourth predetermined set of criteria. The strength assessment module 304 may set the strength level to a fifth strength level when the muscle parameters satisfy a fifth predetermined set of criteria. While the example of five strength levels is provided, the present application is also applicable to other numbers of strength levels. The strength assessment module 304 may set the strength level, for example, using a NN, such as an ANN.

At 612, the steering actuator module 344 determines steering parameters for the steering feel motor 224 based on the strength level of the driver. The steering parameters may include, for example, a power assistance gain 704 of the steering feel motor 224, a linearity boost 708 of the steering feel motor 224, a stiffness 712 of the steering feel motor 224, a steering wheel damping 716 of the steering feel motor 224, and a steering ratio 720 of the steering feel motor 224. The present application, however, is also applicable to other steering parameters and other combinations of steering parameters.

For example, the steering actuator module 344 may set the steering parameters to a first set of steering parameters when the strength level is set to the first strength level. The steering actuator module 344 may set the steering parameters to a second set of steering parameters when the strength level is set to the second strength level. The steering actuator module 344 may set the steering parameters to a third set of steering parameters when the strength level is set to the third strength level. The steering actuator module 344 may set the steering parameters to a fourth set of steering parameters when the strength level is set to the fourth strength level. The steering actuator module 344 may set the steering parameters to a fifth set of steering parameters when the strength level is set to the fifth strength level.

At 616, the steering actuator module 344 controls the steering feel motor 224 based on the steering parameters and controls the steering actuator motor 240 based on the SWA 142.

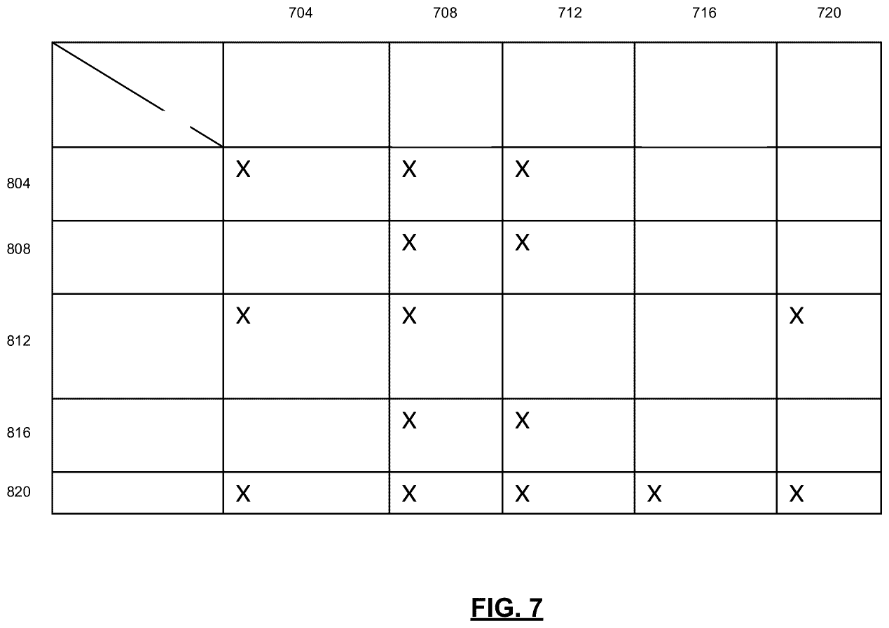

FIG. 7 includes an example table illustrating steering attributes and corresponding steering parameters. An X in the table indicates that the steering parameter affects that steering attribute.

In various implementations, the strength assessment module 304 may determine the steering attributes for the driver based on the muscle parameters. The strength assessment module 304 may determine the steering attributes, for example, using a NN such as an ANN.

In various implementations, the infotainment module 183 may generate a graphical illustration illustrating the steering attributes of the driver. For example, the infotainment module 183 may generate a spider graph or another suitable graphical illustration of the steering attributes of the driver. The infotainment module 183 may visually output the graphical illustration on a display within the passenger cabin.

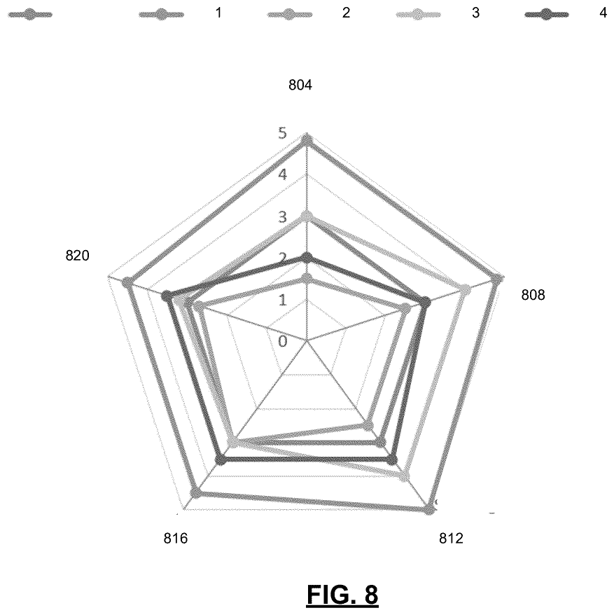

FIG. 8 includes an example spider graph for steering attributes of steering effort 804, steering feedback 808, steering directness and sensitivity 812, returnability to center 816, and linearity 820 for a baseline driver and drivers 1-4.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A steer by wire (SBW) steering system of a vehicle, comprising:
a steering feel motor configured to apply torque to a steering column and a steering wheel;
a steering actuator motor configured to actuate one or more steering components and turn wheels of the vehicle;
a steering assessment module configured to output instructions for a strength assessment of a driver of the vehicle;
an infotainment module configured to, based on the instructions for the strength assessment, at least one of audibly and visibly output an instruction to the driver via at least one of a speaker and a display, the instruction to hold the steering wheel at a first predetermined angle that is one of counterclockwise and counterclockwise relative to a second predetermined angle; and
a steering actuator module configured to, based on the instructions for the strength assessment, control the steering feel motor and output a predetermined torque to the steering column and the steering wheel in the other one of counterclockwise and counterclockwise direction for a predetermined period overlapping the instruction to the driver to hold the steering wheel at the first predetermined angle,
wherein the steering assessment module is configured to determine muscle parameters of the driver based on steering wheel angle measurements taken during the predetermined period, and
wherein the steering actuator module is configured to control torque output of the steering feel motor during driving of the vehicle based on the muscle parameters of the driver.

2. The SBW steering system of claim 1 wherein the muscle parameters include a muscle spring of the driver.

3. The SBW steering system of claim 1 wherein the muscle parameters include a damping coefficient of the driver.

4. The SBW steering system of claim 1 wherein the muscle parameters include a mass coefficient of the driver.

5. The SBW steering system of claim 1 wherein the strength assessment module is configured to determine the muscle parameters using one of an equation and a lookup table that relates steering wheel angles to muscle parameters.

6. The SBW steering system of claim 1 wherein the strength assessment module is configured to determine the muscle parameters using the equation
$$J \ddot{θ} = d \dot{θ} + k θ = τ ,$$
where J is a muscle spring value of the driver, \ddot{θ} is a second derivative of the steering wheel angle, d is a muscle damping value of the driver, \dot{θ} is a first derivative of the steering wheel angle, k is a muscle mass coefficient of the driver, θ is the SWA, and τ is the predetermined torque.

7. The SBW steering system of claim 6 wherein the strength assessment module is configured to determine the muscle parameters using Least Squares.

8. The SBW steering system of claim 1 wherein:
the steering assessment module is configured to determine a strength level of the driver based on the muscle parameters; and
the steering actuator module is configured to:
determine steering parameters based on the strength level; and
control torque output of the steering feel motor during driving of the vehicle based on the steering parameters.

9. The SBW steering system of claim 8 wherein the steering parameters include a power assistance gain provided by the steering feel motor.

10. The SBW steering system of claim 8 wherein the steering parameters include a linearity boost provided by the steering feel motor.

11. The SBW steering system of claim 8 wherein the steering parameters include a steering stiffness provided by the steering feel motor.

12. The SBW steering system of claim 8 wherein the steering parameters include a steering wheel damping provided by the steering feel motor.

13. The SBW steering system of claim 8 wherein the steering parameters include a steering ratio provided by the steering feel motor.

14. The SBW steering system of claim 1 wherein:
the steering assessment module is configured to determine steering attributes based on the muscle parameters of the driver; and
the infotainment module is configured to output a graphical illustration of the steering attributes.

15. The SBW steering system of claim 14 wherein the graphical illustration is a spider graph.

16. The SBW steering system of claim 14 wherein the steering attributes include a steering effort.

17. The SBW steering system of claim 14 wherein the steering attributes include a steering feedback.

18. The SBW steering system of claim 14 wherein the steering attributes include directness and sensitivity.

19. The SBW steering system of claim 14 wherein the steering attributes include returnability to center and a linearity.

20. A steer by wire (SBW) steering method for a vehicle, comprising:
by a steering feel motor, applying torque to a steering column and a steering wheel;
actuating one or more steering components and turn wheels of the vehicle;
outputting instructions for a strength assessment of a driver of the vehicle;
based on the instructions for the strength assessment, at least one of audibly and visibly outputting an instruction to the driver via at least one of a speaker and a display, the instruction to hold the steering wheel at a first predetermined angle that is one of counterclockwise and counterclockwise relative to a second predetermined angle;
based on the instructions for the strength assessment, controlling the steering feel motor and outputting a predetermined torque to the steering column and the steering wheel in the other one of counterclockwise and counterclockwise direction for a predetermined period overlapping the instruction to the driver to hold the steering wheel at the first predetermined angle;
determining muscle parameters of the driver based on steering wheel angle measurements taken during the predetermined period; and
controlling torque output of the steering feel motor during driving of the vehicle based on the muscle parameters of the driver.
